(19) United States
(12) Patent Application Publication
(10) Pub. No.: US 2021/0392655 A1
(43) Pub. Date: Dec. 16, 2021

(54) Scheduling Apparatus and Method

(71) Applicant: Telefonaktiebolaget LM Ericsson (publ), Stockholm (SE)

(72) Inventors: Leif Wilhelmsson, Lund (SE); Naveed Butt, Lund (SE); Rocco Di Taranto, Lund (SE); Dennis Sundman, Sollentuna (SE); Miguel Lopez, Solna (SE); Guido Roland Hiertz, Aachen (DE); Mehmet Burak Guldogan, Stockholm (SE); Lakshmikanth Guntupalli, Lund (SE)

(21) Appl. No.: 17/286,589

(22) PCT Filed: Oct. 19, 2018
(86) PCT No.: PCT/EP2018/078733

§ 371 Date: Apr. 19, 2021

(51) Int. Cl. H04W 72/12; H04L 1/18; H04W 74/08

(52) U.S. Cl. CPC H04W 72/121; H04W 72/1263; H04W 74/0841; H04L 1/1896; H04W 72/1226

(57) ABSTRACT

A method of a scheduling apparatus for multi-user scheduling, wherein the multi-user scheduling may—for example—be in an unlicensed communication environment. The method comprises transmitting a first signal to a first set of users wherein the first signal is indicative of a request for user-specific information, receiving—responsive to transmitting the first signal—a respective second signal from each of a second set of users wherein the second signal is indicative of the requested user-specific information, and scheduling—responsive to receiving the respective second signals—a third set of users based on the received second signals. The second set is a subset of the first set of users, and the third set of users is a subset of, or coincides with, the second set of users. Corresponding scheduling apparatus, wireless communication apparatus and computer program product are also disclosed.

### TECHNICAL FIELD

The present disclosure relates generally to the field of wireless communication. More particularly, it relates to wireless communication scheduling.

### BACKGROUND

To ensure coexistence between different communication devices using the same communication standard and/or between devices using different communication standards, some kind of co-existence mechanism typically needs to be employed. One commonly used co-existence mechanism is the listen-before-talk (LBT) principle, also known as carrier sense multiple access with collision avoidance (CSMA/CA).

LBT (CSMA/CA) is suitable, for example, for communication in unlicensed communication environments (e.g., the 2.45 GHz ISM frequency band and the 5 GHz frequency bands). A complication with unlicensed communication environments is that interference (from stations, STAs, and/or access points, APs) is generally less controllable, and parameters of the interference is not known (or known to a lesser extent), than in licensed communication environments. The purpose of LBT (CSMA/CA) is to avoid collisions, which is achieved by only initiating a transmission when the channel is not busy.

In CSMA/CA, a communication device that intends to use of the wireless communication medium for transmission starts by sensing the channel and determining whether the channel is busy (occupied) or idle (unoccupied). If it is determined that the channel is idle, the intended transmission is initiated. If it is determined that the channel is busy, the communication device defers its intended transmission. A deferred intended transmission may be initiated at a later point in time (e.g., after a later, new, sensing operation where it is determined that the channel is idle).

Historically, the 5 GHz band has been mostly used by communication devices that apply the IEEE 802.11 standard (e.g. 802.11a, 802.11n, 802.11ac, etc.). Before introduction of IEEE 802.11ac, all communication transmissions took place between a single transmitter and a single receiver, and the channel access was typically distributed using the Enhanced Channel Access (EDCA) which employs CSMA/CA as described above.

Application of CSMA/CA simplifies the system design since no central coordination is required. However, as a communication medium (e.g., a frequency band) becomes more heavily loaded, CSMA/CA may be problematic. One reason is that a communication device trying to access the channel will more often find the channel busy in such scenarios, which means that it becomes increasingly hard to support applications requiring a certain quality-of-service (QoS). Another reason is that an increased load on the channel will also cause an increased number of collisions, which in turn will decrease the efficiency of the system. Yet another reason is that the receiver conditions at the intended receiver will likely be more varying. It may be noted that CSMA/CA is based on the transmitter determining the channel conditions it experiences, rather than the channel conditions for the intended receiver; the latter being in principle more important. Thus, when the channel conditions for the transmitter and the receiver are very different, application of CSMA/CA may lead to that a transmission is initiated although the receiver conditions are poor.

Multi-user (MU) transmission (communication transmissions between a single transmitter and a plurality of receivers and/or between a plurality of transmitters and a single receiver) introduces further coexistence issues due to increased coordination aspects. MU-DL transmission is by default scheduled by the transmitter (the access point, AP). MU-UL transmission typically requires scheduling by the receiver (the access point, AP) if the different transmitted signals are to be received reasonably aligned in time, frequency, and power.

In IEEE 802.11ac, transmission from one transmitter to up to four receivers is supported by means of multi-user MIMO (MU-MIMO) in the downlink (DL). In IEEE 802.11ax, transmissions from many transmitters to one receiver is also enabled by means of uplink (UL) MU-MIMO. Furthermore, orthogonal frequency division multiple access (OFDMA) may be used for both DL and UL in IEEE 802.11ax, which enables multi-user transmission in both UL and DL. OFDMA may also be combined with MU-MIMO, e.g., such that some sub-channels are used for MU-MIMO whereas others are used for single user transmission.

One problem with existing solutions for MU scheduling is that they rely on that relatively accurate knowledge of the receiver conditions (e.g., channel conditions as experienced at a receiver, and/or other parameters) are available at the scheduling apparatus (typically associated with an AP). When such solutions are used, for example, in unlicensed bands with severe interference, they will typically not function properly because the receiver conditions (e.g., channel conditions as seen by STAs when receiving in DL) may be highly varying and essentially unknown and unpredictable at the scheduling apparatus (e.g., an AP when transmitting in DL). This typically leads to that it is cumbersome to determine which user to schedule on which resources, and what data rate to use for each user. Consequently, the link performance as well as the system performance can be expected to be far from ideal. Similarly to it being a problem for DL transmissions that receiver conditions are unknown, it is a problem for UL transmissions that transmitter conditions are unknown.

For DL transmissions, US 2017/0164301 A1 seems to disclose a channel-aware scheduling algorithm that may be used to determine an appropriate schedule based on feedback on an instantaneous achievable rate at the user equipments (UEs). The instantaneous achievable rate may depend on the channel quality between the enhanced NodeB (eNB) and UEs and the interference power level measured at the UEs. The eNB may request each UE to send feedback related to the channel quality between the eNB and the corresponding UE.

One additional problem is that it would be desirable to, resource efficiently, enable accurate channel quality measurements that are relevant for the scheduled transmission resource.

Therefore, there is a need for alternative approaches to multi-user scheduling.

### SUMMARY

It should be emphasized that the term “comprises/comprising” when used in this specification is taken to specify the presence of stated features, integers, steps, or components, but does not preclude the presence or addition of one or more other features, integers, steps, components, or groups thereof. As used herein, the singular forms “a”, “an” and “the” are intended to include the plural forms as well, unless the context clearly indicates otherwise.

Generally, when an arrangement is referred to herein, it is to be understood as a physical product; e.g., an apparatus. The physical product may comprise one or more parts, such as controlling circuitry in the form of one or more controllers, one or more processors, or the like.

It is an object of some embodiments to solve or mitigate, alleviate, or eliminate at least some of the above or other disadvantages.

According to a first aspect, this is achieved by a method of a scheduling apparatus for multi-user scheduling. The method comprises transmitting a first signal to a first set of users (wherein the first signal is indicative of a request for user-specific information), receiving, responsive to transmitting the first signal, a respective second signal from each of a second set of users (wherein the second set is a subset of the first set of users, and wherein the second signal is indicative of the requested user-specific information), and scheduling, responsive to receiving the respective second signals, a third set of users based on the received second signals (wherein the third set of users is a subset of, or coincides with, the second set of users).

In some embodiments, the method further comprises coordinating the transmission of the first signal with transmission of corresponding first signals from one or more neighboring scheduling apparatuses.

In some embodiments, the first signal is configured for enabling signal strength measurements by the first set of users.

In some embodiments, the requested user-specific information comprises one or more of a received signal power at the user, a received interference power at the user, a received signal-to-interference value of the user, a duration of interference at the user, an amount of uplink data pending for transmission at the user, a quality-of-service required by the user, an estimated position of or relative angle to one or more interferers; and a prospect uplink transmission power of the user.

In some embodiments, the first signal comprises an acknowledgement message and/or a negative acknowledgement message related to a previous uplink data reception.

In some embodiments, the second signal comprises an acknowledgement message and/or a negative acknowledgement message related to a previous downlink data transmission.

In some embodiments, the method further comprises transmitting, to one or more users of the third set of users, downlink data according to the scheduling.

In some embodiments, the method further comprises transmitting, to one or more users of the third set of users, an uplink scheduling message indicative of the scheduling.

In some embodiments, the method further comprises transmitting, to one or more users of a fourth set of users, downlink data according to the scheduling, and transmitting, to one or more users of a fifth set of users, an uplink scheduling message indicative of the scheduling, wherein a union set of the fourth and fifth sets of users coincides with the third set of users.

In some embodiments, the first signal is specifically directed to each user of the first set of users.

In some embodiments, the first signal is transmitted using beamforming towards each user of the first set.

In some embodiments, the first signal is further indicative of, for each user of the first set of users, a communication resource allocated to the user for transmission of the second signal.

In some embodiments, each of the respective second signals is configured for enabling its originating user to be distinguishable at the scheduling apparatus.

In some embodiments, each of the respective second signals is received using a respective receiver beamforming direction.

In some embodiments, the first signal is further indicative of communication resources associated with the second signal and allocated for random access.

In some embodiments, receiving the respective second signals comprises receiving a respective random access request from one or more users of the first set of users.

In some embodiments, the multi-user scheduling is in an unlicensed communication environment. Alternatively or additionally, according to some embodiments the multi-user scheduling may be in a communication environment where a listen-before-talk principle is applied.

It should be noted that even if the background and the problem formulation has been provided in the context of an unlicensed communication environment, embodiments may be equally applicable in other scenarios, e.g., in a licensed communication environment.

A second aspect is a computer program product comprising a non-transitory computer readable medium, having thereon a computer program comprising program instructions. The computer program is loadable into a data processing unit and configured to cause execution of the method according to the first aspect when the computer program is run by the data processing unit.

A third aspect is a scheduling apparatus for multi-user scheduling. The scheduling apparatus comprises controlling circuitry configured to cause transmission of a first signal to a first set of users (wherein the first signal is indicative of a request for user-specific information), reception, responsive to transmission of the first signal, of a respective second signal from each of a second set of users (wherein the second set is a subset of the first set of users, and wherein the second signal is indicative of the requested user-specific information), and scheduling, responsive to reception of the respective second signals, of a third set of users based on the received second signals (wherein the third set of users is a subset of, or coincides with, the second set of users).

A fourth aspect is a wireless communication apparatus comprising the scheduling apparatus of the third aspect.

In some embodiments, any of the above aspects may additionally have features identical with or corresponding to any of the various features as explained above for any of the other aspects.

An advantage of some embodiments is that alternative approaches to multi-user scheduling are provided.

Another advantage of some embodiments is that accurate channel quality measurements that are relevant for the scheduled transmission resource are enabled.

Yet an advantage of some embodiments is that channel quality measurements are enabled in a resource efficient manner.

Yet an advantage of some embodiments is that, approaches to multi-user scheduling are provided for both UL and DL communication.

Another advantage of some embodiments is that approaches to multi-user scheduling are provided which are suitable when a communication medium becomes heavily loaded.

Yet an advantage of some embodiments is improved channel (e.g., spectrum) efficiency.

### BRIEF DESCRIPTION OF THE DRAWINGS

Further objects, features and advantages will appear from the following detailed description of embodiments, with reference being made to the accompanying drawings. The drawings are not necessarily to scale, emphasis instead being placed upon illustrating the example embodiments.

FIG. 1 is a schematic drawing illustrating a communication scenario according to some embodiments;

FIG. 2 is a flowchart illustrating example method steps according to some embodiments;

FIG. 3 is a schematic drawing illustrating signaling according to some embodiments;

FIG. 4 is a schematic block diagram illustrating an example arrangement according to some embodiments; and

FIG. 5 is a schematic drawing illustrating an example computer readable medium according to some embodiments.

### DETAILED DESCRIPTION

As already mentioned above, it should be emphasized that the term “comprises/comprising” when used in this specification is taken to specify the presence of stated features, integers, steps, or components, but does not preclude the presence or addition of one or more other features, integers, steps, components, or groups thereof. As used herein, the singular forms “a”, “an” and “the” are intended to include the plural forms as well, unless the context clearly indicates otherwise.

Embodiments of the present disclosure will be described and exemplified more fully hereinafter with reference to the accompanying drawings. The solutions disclosed herein can, however, be realized in many different forms and should not be construed as being limited to the embodiments set forth herein.

As mentioned above, relying on CSMA/CA may be problematic when a communication medium (e.g., a frequency band) becomes more heavily loaded. Furthermore, it may be desirable to support transmission from one transmitter to several receivers, as well as from several transmitters to one receiver.

To achieve high performance in wireless systems it is typically important to adjust transmissions to current channel conditions and to explore good channels while avoiding poor channels, if possible. When transmissions are controlled by a network node (e.g., an access point) and the network node selects among a plurality of devices (users, e.g., STAs) to transmit to, the performance can typically be greatly improved if the network node is able to schedule devices that currently have good channel conditions as seen by the intended receiver (a.k.a. opportunistic scheduling) rather than scheduling in some other way (e.g. a round robin fashion). To be able to accurately apply opportunistic scheduling, it is of course of importance to obtain channel knowledge that is as accurate as possible.

When a wireless system operates in unlicensed frequency bands, it may be especially challenging to obtain accurate channel knowledge since the interference (e.g., from other devices) can be highly unpredictable. When the channel conditions vary due to varying interference rather than variations of the desired signal, traditional scheduling algorithms may no longer provide desired system performance.

One way to address one or more of these problems is to apply multi-user scheduling approaches as presented herein. According to some embodiments, multi-user scheduling approaches are provided for UL and/or DL scheduling. Furthermore, some embodiments enable accurate channel quality measurements that are relevant for the scheduled transmission resource; in a resource efficient way.

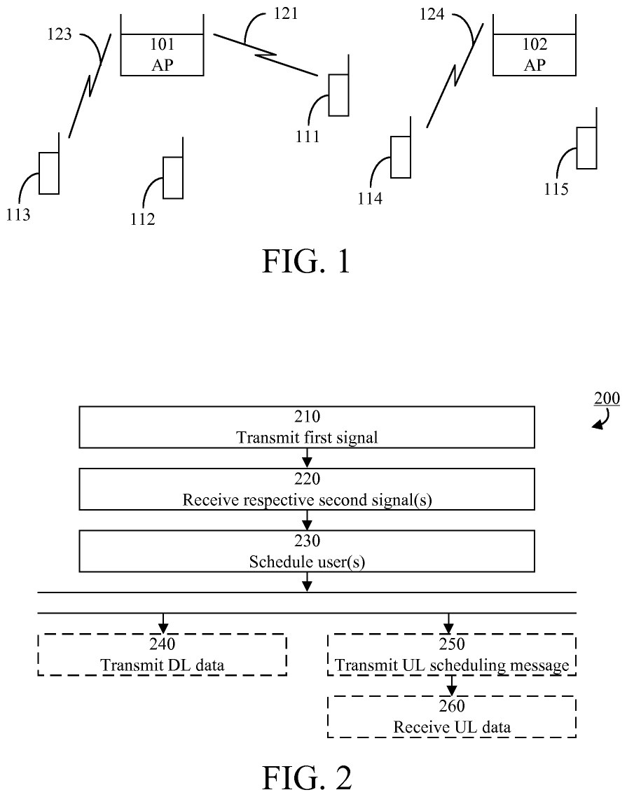

FIG. 1 schematically illustrates a communication scenario according to some embodiments. An access point (AP) 101 serves three STAs 111, 112, 113 and a neighboring access point (AP) 102 serves two STAs 114, 115. When the AP 101 would like to transmit to STA 111 as illustrated by 121, the reception at STA 111 may be interfered by a simultaneous transmission 124 by the neighboring AP 102 intended for the STA 114. If the AP 101 would have some knowledge regarding the upcoming transmission 124, it may determine to schedule a transmission 123 to STA 113 instead since the reception at STA 113 will not be interfered by the simultaneous transmission 124.

This and other interference scenarios are well known in the art as well as scheduling approaches to avoid severe interference. One problem that may be particularly prominent in unlicensed communication environments is how to achieve relevant knowledge regarding upcoming interfering transmissions (e.g., 124) and/or other information relevant for scheduling in time for the scheduling decision by AP 101. Sometimes, such information is needed for the scheduling decision before the neighboring AP 102 has even determined that the interfering transmission 124 is to be performed.

In the following, embodiments will be described where these and/or other problems are mitigated by a multi-user scheduling approach.

FIG. 2 illustrates an example method 200 according to some embodiments. The method is a multi-user scheduling method and may be performed by a scheduling apparatus (e.g., AP 101 of FIG. 1). According to some embodiments, the method may be applied in an unlicensed communication environment and/or an environment where a listen-before-talk procedure is compulsory. It should be noted, however, that embodiments may be equally suitable and/or applicable for other communication environments.

In step 210, a first signal is transmitted to a first set of users (e.g., STAs 111, 113 of FIG. 1), wherein the first signal is indicative of a request for user-specific information.

The first set of users is typically a subset of the users served by the scheduling apparatus. The subset comprises one or more users; typically two or more users, or a plurality of users. The first subset may be determined by the scheduling apparatus to comprise prospect users for scheduling (e.g., in a particular time resource). Typically, the number of prospect users for scheduling comprised in the first subset is larger than the number of users actually scheduled in step 230.

Generally, when the terminology “subset of a set” is used herein, it may be defined as the subset being a strict subset of the set (i.e., the subset having a lower cardinality than the set, and being completely comprised in the set), or as the subset being a non-strict subset of the set (i.e., the cardinality of the subset being smaller than, or equal to, the cardinality of the set, and the subset being completely comprised in the set). A strict subset may also be denoted as a proper subset.

In 802.11ax, UL scheduling is achieved by means of the so-called trigger frame (TF). A TF is sent from the AP to the STAs that are scheduled for UL transmission. The TF indicates parameters for the UL transmission (e.g., communication resources for the UL transmission, transmission power, etc.). No sounding is applied for UL scheduling.

The first signal may be a sounding signal. The sounding signal may, for DL scheduling, replace the request-to-send (RTS) signal of CSMA/CA according to some embodiments. The uplink scheduling message may, for UL scheduling, replace the trigger frame (TF) signaling of CSMA/CA according to some embodiments.

In step 220, a respective second signal is received (responsive to—possibly directly responsive to—transmitting the first signal) from each of a second set of users, wherein the second signal is indicative of the requested user-specific information. The second set is a (strict or non-strict) subset of the first set of users.

The second signal may be a sounding response signal. The sounding response signal may, for DL scheduling, replace the clear-to-send (CTS) signal of CSMA/CA according to some embodiments.

In step 230 (responsive to—possibly directly responsive to—receiving the respective second signals), a third set of users is scheduled based on the received second signals. The third set of users is a subset of, or coincides with, the second set of users. Thus, the third set of users is a strict or non-strict subset of the second set of users. The scheduling may be for DL and/or UL transmission.

When the scheduling is for DL transmission, the method may further comprise transmitting downlink data according to the scheduling to one or more users of the third set of users, as illustrated by step 240. The one or more users of the third set may be all users of the third set (when all users of the third set are scheduled for DL transmission in step 230) or less than all of the users of the third set (when less than all of the users of the third set are scheduled for DL transmission in step 230).

When the scheduling is for UL transmission, the method may further comprise transmitting an uplink scheduling message indicative of the scheduling to one or more users of the third set of users, as illustrated by step 250, and receiving uplink data according to the scheduling from the one or more users of the third set of users, as illustrated by step 260. The uplink scheduling message may, for UL scheduling, replace the trigger frame (TF) signaling of CSMA/CA according to some embodiments. The one or more users of the third set may be all users of the third set (when all users of the third set are scheduled for UL transmission in step 230) or less than all of the users of the third set (when less than all of the users of the third set are scheduled for UL transmission in step 230).

Generally, the one or more users of the third set scheduled for DL transmission may be the same as, or different (overlapping or disjunct) from, the one or more users of the third set scheduled for UL transmission.

When step 230 comprises scheduling for both DL and UL transmissions, the method may comprise transmitting downlink data according to the scheduling (step 240) to one or more (e.g., all) users of a fourth set of users, and transmitting an uplink scheduling message indicative of the scheduling (step 250) to one or more (e.g., all) users of a fifth set of users, wherein a union set of the fourth and fifth sets of users coincides with the third set of users.

In 802.11ax, DL scheduling is achieved in that the AP sends a request-to-send (RTS) packet to the STAs to whom it intends to send DL data. STAs that are addressed by the RTS packet, and are able to decode it, responds with a clear-to-send (CTS) packet.

A purpose of the RTS-CTS exchange is to address the fact that a DL transmission from an AP may not be heard by STAs not associated with the AP. Such STAs may therefore potentially initiate a transmission which may cause interference to the DL transmission of the AP when received at an intended STA. However, the CTS is typically heard by STAs that may cause such interference, and then such STAs typically do not initiate any UL transmission. The STA hearing the CTS transmission may be either an AP or a non-AP STA.

The CTS packets sent from different STAs are identical and the AP can generally not identify which ones of the addressed STAs responded with a CTS; only whether at least one response has been received.

Thus, one drawback of the 802.11ax DL scheduling approach is that the AP will not be able to identify which STAs sent a CTS. Another drawback is that the purpose of the CTS is only to clear the channel so that no transmission from any overlapping basic service set (OBSS) is initiated. The AP does not get any information about the receiver conditions at the STA. Furthermore, the AP makes the scheduling decision regarding what STAs to address before sending the RTS.

In 802.11ax, UL scheduling is achieved by means of the so-called trigger frame (TF). A TF is sent from the AP to the STAs that are scheduled for UL transmission. The TF indicates parameters for the UL transmission (e.g., communication resources for the UL transmission, transmission power, etc.). No sounding is applied for UL scheduling.

One drawback of the 802.11ax DL scheduling approach is that information used for the scheduling decision is not necessarily relevant. In particular when the communication system operates in an unlicensed band with rapid variations of the channel conditions, it is important that the information used for the scheduling decision is obtained as recently as possible.

There are a number of differences between the first signal (e.g., sounding signal, sounding packet; compare with step 210 of FIG. 2) and DL scheduling in IEEE 802.11, where the RTS packet is used, as well as UL scheduling in IEEE 802.11.

Firstly, the STAs addressed by the first signal and the STAs that eventually will be scheduled may differ.

For DL scheduling, a STA may be addressed by the first signal although the AP does not currently have any data intended for that STA. Even if the AP has data for a STA and it is addressed by the first signal, it may eventually not be scheduled (e.g., based on user-specific information received in the second signal).

For UL scheduling, a STA may be addressed by the first signal although the AP does not know whether the STA has data to send. Even if the STA has data to send, it may eventually not be scheduled. When the second signal can be used to determine that the quality of a signal received from the STA would be poor, the UL data packet may not be scheduled. Such an approach addresses the situation when a STA has data to send but cannot actually send it efficiently (e.g., due to poor channel conditions) by avoiding that the AP allocates UL resources to that STA. Thereby, UL resources are saved, since the second signal is typically short in comparison with a signal for transmitting the UL data packet.

Secondly, a purpose of the first signal is to solicit information from a selected set of STAs; information that potentially will be used in deciding what STAs to schedule, and how.

Thirdly, the first signal may typically be sent using beamforming, where the beamforming patterns are related to (although not necessarily identical to) beamforming patterns that will potentially be used for the actual data transmission. The beamforming pattern may for example be chosen such that it is one of several patterns that orthogonally divides the cell coverage into a number of sectors.

There are a number of differences between the second signal (e.g., sounding response signal, sounding response, sounding response packet) and DL scheduling in IEEE 802.11, where the CTS packet is used, as well as UL scheduling in IEEE 802.11.

Firstly, a purpose of the second signal is to provide information that is requested by the AP in the first signal. Thus, the content of the second signal may vary between users and may depend on what user-specific information is requested. The user-specific information is typically intended to aid the AP in the scheduling. Typical user-specific information for DL scheduling may include received signal power, interference power, and information related to the duration of the interference, for example. Typical user-specific information for UL scheduling may include an amount of data the STA has to send, quality of service (QoS) requirements related to the data, and buffer status of one or more transmit buffers, for example. Other typical user-specific information for UL scheduling may include an indication of the transmission power that can be used by the STA (which may be used by the AP to determine whether or not to schedule that STA). When operating in an unlicensed frequency band and performing CSMA/CA, it may be possible to access the channel more aggressively (e.g., by declaring the channel to be idle at a higher threshold value) if the transmission power is reduced. Therefore, the transmit power of a STA may vary form one transmission to the next.

Secondly, the second signals from the different addressed STAs are distinguishable at the AP. Thus, the AP will know which ones of the addressed STAs have responded, and will also be able to decode the respective responses. The second signals from different STAs may, for example, be multiplexed in the frequency domain (OFDMA), or in the spatial domain (SDMA), or both.

Thirdly, the second signal may typically be transmitted and/or received using beamforming, where the beamforming pattern are related to (although not necessarily identical to) beamforming patterns that will potentially be used for transmission and/or reception of the actual data transmission.

Thus, here are a number of differences between scheduling according to embodiments presented herein and scheduling according to IEEE 802.11. For example, with explicit information about receiver conditions for the different STAs, the AP will be able to opportunistically schedule the STAs which have favorable receiver conditions and defer from transmission to STAs whose receiver conditions are currently less favorable. The AP may select not to send any data to some of the STAs although it has received a second signal (e.g., for STAs indicating that they have poor receiver conditions).

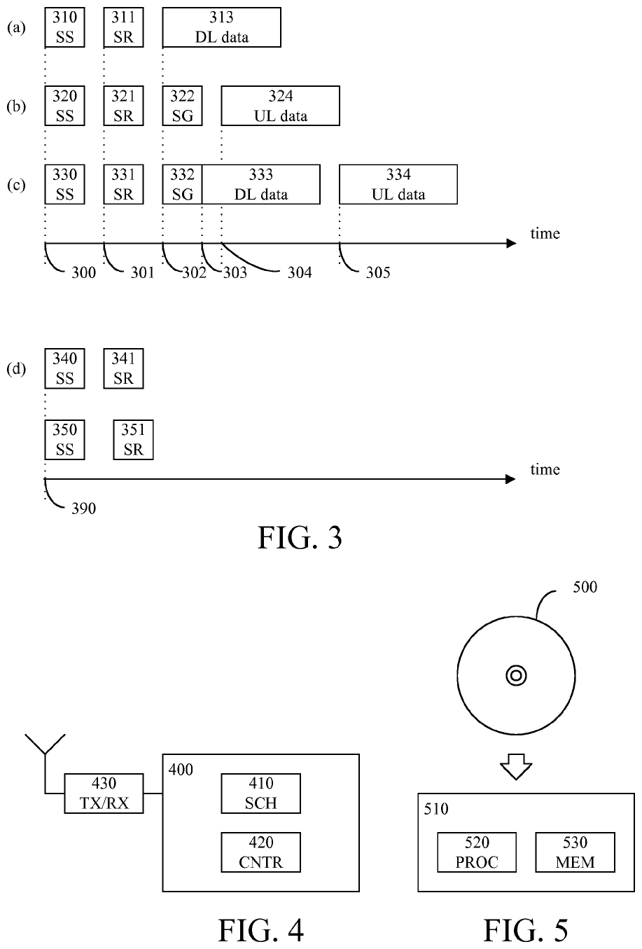

FIG. 3 schematically illustrates a signaling according to some embodiments. Four example scenarios are shown and denoted (a), (b), (c) and (d), respectively.

Example scenario (a) is a DL scheduling scenario, which comprises transmission of the first signal 310 (sounding signal, SS), reception of the second signal (sounding response, SR) 311, and transmission of DL data 313 according to the scheduling.

Example scenario (b) is an UL scheduling scenario, which comprises transmission of the first signal 320 (sounding signal, SS), reception of the second signal (sounding response, SR) 321, transmission of the uplink scheduling message (scheduling grant, SG) 322, and reception of UL data 324 according to the scheduling.

Example scenario (c) is a DL/UL scheduling scenario, which comprises transmission of the first signal 330 (sounding signal, SS), reception of the second signal (sounding response, SR) 331, transmission of the uplink scheduling message (scheduling grant, SG) 332, transmission of DL data 333 according to the scheduling, and reception of UL data 334 according to the scheduling.

An advantage with scheduling DL/UL separately as illustrated in scenarios (a) and (b) is that the UL data transmission is close in time to the first and second signals, which typically improves the relevance of the user-specific information.

An advantage with combining DL and UL scheduling as illustrated in scenario (c) is signaling efficiency. For example, the amount of overhead signaling needed for the sounding is reduced. Specifically, the packet exchange consisting of the first and second signals can be used to obtain information to perform both DL and UL scheduling.

Furthermore, the uplink scheduling message and the DL data can be efficiently transmitted according to the scenario (c). This is due to that there is no need for any switching time between these transmissions. Also, less time will be needed for synchronization and channel estimation since the information obtained for the uplink scheduling message can be used also for the DL data transmission following directly thereafter.

It should be noted, however, that DL and UL scheduling may be combined in other ways than illustrated in scenario (c). For example, one combination scenario may correspond to the scenario (b) where the UL data 324 is followed by a DL data transmission.

For combined UL and DL scheduling, the uplink scheduling message may comprise scheduling information for both the DL and the UL. For example, the scheduling information may be divided into two parts (similarly to, e.g., 802.11—when scheduling more than one user).

A first part (e.g., part A) may carry control information intended for all scheduled STAs. Such information may, for example, include an indication of which STAs are scheduled in DL and UL and what resources are allocated to the respective STAs. Typically, the first part of the scheduling information may be transmitted such that it can be heard by all STAs (e.g., over the full bandwidth).

A second part (e.g., part B) may carry control information intended for the individual STAs. Such information may typically be transmitted using the resources indicated in the first part (i.e., the second part may be sent using the same resources as the data for the corresponding STA).

UL scheduling may be triggered by receipt of a random access request from one or more of the users served by the scheduling apparatus and/or by receipt of time-varying information relevant for UL scheduling (e.g., a buffer status) from some users of the first set. In some embodiments, the first signal may be seen as a prompt or polling to the users of the first set to indicate whether they need UL scheduling; by allowing them to transmit a random access request (e.g., on some specified communication resources associated with the second signal) and/or by requesting time-varying information relevant for UL scheduling.

Generally, the transmissions of steps 240 and 250 and/or the reception of step 260 may be responsive to—possibly directly responsive to—the reception of the second signals of step 220 and/or the scheduling of step 230. For example, the scheduling of steps 230 may be directly responsive to the reception of the second signals of step 220, and the scheduling may comprise scheduling the transmissions of steps 240 and 250 and/or the reception of step 260 within a maximum allowable time interval (e.g., starting with the reception of the second signals of step 220).

The user-specific information is typically time-varying information relevant for UL and/or DL scheduling. Hence, it is preferable that the user-specific information is retrieved such that it is relevant for the point in time when the intended transmission is to take place. Such relevance may typically be achieved when the user-specific information is retrieved as close as possible in time to the point in time when the intended transmission is to take place. For example, the relevance may increase with a decrease of a length of a time interval between a point in time when the user-specific information is retrieved and the point in time when the intended transmission is to take place.

Therefore, one or more of the following (or other relevant) time intervals may be restricted (compare with the maximum allowable time interval mentioned above): the time interval between transmission (210, 300) of the first signal and reception (220, 301) of the second signal, the time interval between reception (220, 301) of the second signal and scheduling (230) of the third set of users, the time interval between reception (220, 301) of the second signal and UL/DL transmissions according to the scheduling (240, 250, 260, 302, 303, 304, 305).

The restriction may be such that the user-specific information received in the second signal will still be relevant (e.g., essentially the same) at the point in time of UL/DL transmissions according to the scheduling. For example, the time interval between an end of the first signal and a start of the second signal may be limited to 20 μs, or less.

Alternatively or additionally, the restriction may be such that it is not possible for users in the communication environment to initiate transmissions before the point in time of UL/DL transmissions according to the scheduling. This may be particularly relevant in a communication environment where CSMA/CS is applied.

Hence, one or more of the transmission of the first signal and the reception of the second signal may be time-wise immediately associated with the upcoming UL/DL transmissions to be scheduled.

As mentioned above, the user-specific information is typically time-varying information relevant for UL and/or DL scheduling. Examples of user-specific information may comprise (but is not limited to) one or more of: a received signal power at the user (particularly relevant for DL scheduling), a received interference power at the user (particularly relevant for DL scheduling), a received signal-to-interference value of the user (particularly relevant for DL scheduling), a duration of interference at the user (particularly relevant for DL scheduling), an estimated position of or relative angle to one or more interferers, a buffer status of the user (particularly relevant for UL scheduling), an amount of uplink data pending for transmission at the user (particularly relevant for UL scheduling), a quality-of-service required by the user (particularly relevant for DL and/or UL scheduling), and a prospect uplink transmission power of the user (particularly relevant for UL scheduling).

For example, a user may monitor how the interference level is varying and estimate interference parameters. One example is that the user may estimate interference duration based on statistics regarding the duration of a packet. If it can be estimated that interference will be of short duration, one attempt to mitigate the interference may comprise sending long packets (where the data in the long packets may be properly coded and/or interleaved, or where the data in the long packets is repeated a few times).

For example, a user may monitor how the estimated position of or relative angle to one or more interferers using various receiver beamforming direction techniques.

In some embodiments, the transmission of the first signal is coordinated with transmission(s) of corresponding first signals from one or more neighboring scheduling apparatuses. The coordination may comprise transmitting the first signals simultaneously, for example.

Example scenario (d) is a scheduling scenario where first signals 340 and 350 (sounding signal, SS) are transmitted simultaneously, starting at time 390. The first signals 340 and 350 may be transmitted from two different neighboring scheduling apparatuses (e.g., 101 and 102, respectively, of the scenario illustrated in FIG. 1).

A user served by the scheduling apparatus transmitting SS 340 may consider SS 350 as interference and responds by transmission of a corresponding second signal (sounding response, SR) 341. Correspondingly, a user served by the scheduling apparatus transmitting SS 350 may consider SS 340 as interference and responds by transmission of a corresponding second signal (sounding response, SR) 351.

In scenario (d), communication according to the scheduling (compare with 313, 322, 324, 332, 333, 334) is not shown.

In some embodiments, the first signal is configured for enabling signal strength measurements by the first set of users and/or for enabling interference strength measurements by the first set of users (and/or by users served by a neighboring access point). This approach may be resource efficient since no separate reference signals for measurements are needed; the requests for measurements (the first signal) is also a reference signal for measurements.

Furthermore, performing measurements of signal strength and/or interference strength on the first signal may give accurate (or at least relevant) estimations of the conditions of the future point in time of UL/DL transmissions. This is because the first signal is sent to users of the first set of users and the scheduling apparatus schedules (only) users of a third set, which is a subset of the first set. Thus, measurements performed on the first signal will typically represent a worst case interference scenario for each of the users of the first set. This may be particularly relevant when transmission of first signals is coordinated between neighboring scheduling apparatuses.

The first signal may be specifically directed to each user of the first set of users. Thus, the transmission of the first signal may be seen as a multicast (group-addressed) transmission and/or as dedicated transmission of a plurality of first signals. The feature of the first signal being specifically directed to each user of the first set of users may be achieved by any suitable approach, for example, by transmitting the first signal(s) using beamforming towards the users of the first set and/or by letting the first signal(s) be indicative of respective user identities for the users of the first set.

Each of the respective second signals may be configured for enabling its originating user to be distinguishable at the scheduling apparatus. This may be achieved by any suitable approach, for example, by receiving the respective second signals using a respective receiver beamforming direction (e.g., associated with the same direction in which the first signal was transmitted) and/or by the second signals being indicative of respective user identities for the users of the second set.

Alternatively or additionally, the originating user of the second signals may be distinguishable at the scheduling apparatus via a communication resource (e.g., in time domain and/or frequency domain) on which the second signal is received. In such embodiments, the first signal may be indicative of, for each user of the first set of users, a communication resource allocated to the user for transmission of the second signal.

In various embodiments, the method may accommodate acknowledgement signaling (ACK/NACK) for previously transmitted UL and/or DL data.

An acknowledgement message (ACK) and/or a negative acknowledgement message (NACK) related to a previous uplink data reception may be comprised in (or otherwise associated with; e.g., transmitted in a same time and/or frequency resource) any of the first signal, the uplink scheduling message, and the downlink data.

Alternatively or additionally, an acknowledgement message (ACK) and/or a negative acknowledgement message (NACK) related to a previous downlink data transmission may be comprised in (or otherwise associated with; e.g., received in a same time and/or frequency resource) any of the second signal and the uplink data.

In some embodiments, ACK/NACK messages may be allowed in the resources intended for any of the uplink scheduling message, the uplink data, and the downlink data even if uplink scheduling message, uplink data, and/or downlink data is not communicated.

When DL ACK/NACK messages are sent with the second signals, the AP may indicate in the first signal which STAs it wants to have ACK/NACK reports from, and what resources within the second signal should be used for that purpose.

A possible drawback with sending ACK/NACK messages with the first and/or second signals is that the time between reception of data and ACK/NACK transmission may be relatively short, leaving little time for a receiver to process the received data before the ACK/NACK message needs to be sent.

A possible drawback with sending ACK/NACK messages with the DL and/or UL data is that it is typically not suitable when the DL/UL data is transmitted/received using beamforming, since the ACK/NACK message may be to/from a STA that is not scheduled for new DL and/or UL data. Then, this approach comes at an additional signaling cost.

In various embodiments, the method may provide for random access requests from one or more of the users. The first signal may be indicative of communication resources associated with the second signal and/or the uplink data and allocated for random access. Thus, receiving the respective second signals may comprise receiving a respective random access request from one or more users of the first set of users (e.g., from one or more users of the second and/or third set of users).

The allocation for random access may be for all users of the first set or only for some specific users indicated by the first signal (e.g., to decrease the random access collision probability).

The communication resources allocated for random access may, for example, be resources in a time domain and/or a frequency domain (e.g., subcarriers of orthogonal frequency division multiplexing, OFDM).

In some embodiments, the association with the second signal and/or the uplink data may be that the communication resources allocated for random access are comprised in communication resources allocated for the second signal and/or the uplink data. Alternatively, the association with the second signal and/or the uplink data may be that the communication resources allocated for random access coincide with communication resources allocated for the second signal and/or the uplink data in one or more resource domains (e.g., time, frequency).

FIG. 4 schematically illustrates an example arrangement 400 according to some embodiments. The arrangement may be a scheduling apparatus for multi-user scheduling, and/or may be comprise in a wireless communication apparatus (e.g., an access point). The arrangement 400 may, for example, be configured to cause execution of (e.g., configured to perform) method steps of FIG. 1 or otherwise described herein.

According to some embodiments, the arrangement may be suitable for use in an unlicensed communication environment and/or an environment where a listen-before-talk procedure is compulsory. It should be noted, however, that embodiments may be equally suitable and/or applicable for other communication environments.

The scheduling apparatus comprises controlling circuitry (CNTR; e.g. a controller) 420.

The controlling circuitry is configured to cause transmission of a first signal to a first set of users (wherein the first signal is indicative of a request for user-specific information), and reception of a respective second signal indicative of the requested user-specific information from each of a second set of users responsive to transmission of the first signal (wherein the second set is a subset of the first set of users). To this end the arrangement 400 may comprise, or be otherwise associated with (e.g., connectable/connected to) transceiving circuitry (TX/RX; e.g. a transceiver) 430 configured to transmit the first signal and receive the second signals.

The controlling circuitry is also configured to cause scheduling of a third set of users based on the received second signals, responsive to reception of the respective second signals (wherein the third set of users is a subset of, or coincides with, the second set of users). To this end the arrangement 400 may comprise, or be otherwise associated with (e.g., connectable/connected to) scheduling circuitry (SCH; e.g. a scheduler) 410 configured to schedule the third set of users based on the received second signals.

The controlling circuitry may also be configured to cause one or more of: transmission of downlink data according to the scheduling, transmission of uplink scheduling messages indicative of the scheduling, and reception of downlink data according to the scheduling; in accordance with the description herein. The transceiving circuitry 430 may be configured to transmit the downlink, transmit the uplink scheduling messages, and/or receive the downlink data according to the scheduling.

Generally, when an arrangement is referred to herein, it is to be understood as a physical product; e.g., an apparatus. The physical product may comprise one or more parts, such as controlling circuitry in the form of one or more controllers, one or more processors, or the like.

The described embodiments and their equivalents may be realized in software or hardware or a combination thereof. The embodiments may be performed by general purpose circuitry. Examples of general purpose circuitry include digital signal processors (DSP), central processing units (CPU), co-processor units, field programmable gate arrays (FPGA) and other programmable hardware. Alternatively or additionally, the embodiments may be performed by specialized circuitry, such as application specific integrated circuits (ASIC). The general purpose circuitry and/or the specialized circuitry may, for example, be associated with or comprised in a wireless communication apparatus such as an access point.

Embodiments may appear within an electronic apparatus (such as a wireless communication apparatus) comprising arrangements, circuitry, and/or logic according to any of the embodiments described herein. Alternatively or additionally, an electronic apparatus (such as a wireless communication apparatus) may be configured to perform methods according to any of the embodiments described herein.

According to some embodiments, a computer program product comprises a computer readable medium such as, for example a universal serial bus (USB) memory, a plug-in card, an embedded drive or a read only memory (ROM). FIG. 5 illustrates an example computer readable medium in the form of a compact disc (CD) ROM 500. The computer readable medium has stored thereon a computer program comprising program instructions. The computer program is loadable into a data processor (PROC) 520, which may, for example, be comprised in a wireless communication apparatus 510. When loaded into the data processing unit, the computer program may be stored in a memory (MEM) 530 associated with or comprised in the data-processing unit. According to some embodiments, the computer program may, when loaded into and run by the data processing unit, cause execution of method steps according to, for example, any of the methods illustrated in FIG. 2 or otherwise described herein.

Generally, all terms used herein are to be interpreted according to their ordinary meaning in the relevant technical field, unless a different meaning is clearly given and/or is implied from the context in which it is used.

Reference has been made herein to various embodiments. However, a person skilled in the art would recognize numerous variations to the described embodiments that would still fall within the scope of the claims.

For example, the method embodiments described herein discloses example methods through steps being performed in a certain order. However, it is recognized that these sequences of events may take place in another order without departing from the scope of the claims. Furthermore, some method steps may be performed in parallel even though they have been described as being performed in sequence. Thus, the steps of any methods disclosed herein do not have to be performed in the exact order disclosed, unless a step is explicitly described as following or preceding another step and/or where it is implicit that a step must follow or precede another step.

In the same manner, it should be noted that in the description of embodiments, the partition of functional blocks into particular units is by no means intended as limiting. Contrarily, these partitions are merely examples. Functional blocks described herein as one unit may be split into two or more units. Furthermore, functional blocks described herein as being implemented as two or more units may be merged into fewer (e.g. a single) unit.

Any feature of any of the embodiments disclosed herein may be applied to any other embodiment, wherever suitable. Likewise, any advantage of any of the embodiments may apply to any other embodiments, and vice versa.

Hence, it should be understood that the details of the described embodiments are merely examples brought forward for illustrative purposes, and that all variations that fall within the scope of the claims are intended to be embraced therein.

1-36. (canceled)

37. A method of a scheduling apparatus for multi-user scheduling, the method comprising:
transmitting a first signal to a first set of users, wherein the first signal is indicative of a request for user-specific information;
receiving, responsive to transmitting the first signal, a respective second signal from each of a second set of users, wherein the second set is a subset of the first set of users, and wherein the second signal is indicative of the requested user-specific information; and
scheduling, responsive to receiving the respective second signals, a third set of users based on the received second signals, wherein the third set of users is a subset of, or coincides with, the second set of users.

38. The method of claim 37, further comprising coordinating the transmission of the first signal with transmission of corresponding first signals from one or more neighboring scheduling apparatuses.

39. The method of claim 37, wherein the first signal is configured for enabling signal strength measurements by the first set of users.

40. The method of claim 37, wherein the requested user-specific information comprises one or more of:
a received signal power at the user;
a received interference power at the user;
a received signal-to-interference value of the user;
a duration of interference at the user;
an amount of uplink data pending for transmission at the user;
a quality-of-service required by the user;
an estimated position of or relative angle to one or more interferers; and
a prospect uplink transmission power of the user.

41. The method of claim 37, wherein the first signal comprises an acknowledgement message and/or a negative acknowledgement message related to a previous uplink data reception.

42. The method of claim 37, wherein the second signal comprises an acknowledgement message and/or a negative acknowledgement message related to a previous downlink data transmission.

43. The method of claim 37, further comprising transmitting, to one or more users of the third set of users, downlink data according to the scheduling.

44. A computer program product comprising a non-transitory computer readable medium (500), having thereon a computer program comprising program instructions that, when executed by processor of a scheduling apparatus, configure the scheduling apparatus to:
transmit a first signal to a first set of users, wherein the first signal is indicative of a request for user-specific information;
receive, responsive to transmitting the first signal, a respective second signal from each of a second set of users, wherein the second set is a subset of the first set of users, and wherein the second signal is indicative of the requested user-specific information; and
schedule, responsive to receiving the respective second signals, a third set of users based on the received second signals, wherein the third set of users is a subset of, or coincides with, the second set of users.

45. A scheduling apparatus for multi-user scheduling, the scheduling apparatus comprising controlling circuitry configured to cause:
transmission of a first signal to a first set of users, wherein the first signal is indicative of a request for user-specific information;
reception, responsive to transmission of the first signal, of a respective second signal from each of a second set of users, wherein the second set is a subset of the first set of users, and wherein the second signal is indicative of the requested user-specific information; and
scheduling, responsive to reception of the respective second signals, of a third set of users based on the received second signals, wherein the third set of users is a subset of, or coincides with, the second set of users.

46. The scheduling apparatus of claim 45, wherein the controlling circuitry is further configured to cause coordination of the transmission of the first signal with transmission of corresponding first signals from one or more neighboring scheduling apparatuses.

47. The scheduling apparatus of claim 45, wherein the first signal is configured for enabling signal strength measurements by the first set of users.

48. The scheduling apparatus of claim 45, wherein the requested user-specific information comprises one or more of:
a received signal power at the user;
a received interference power at the user;
a received signal-to-interference value of the user;
a duration of interference at the user;
an amount of uplink data pending for transmission at the user;
a quality-of-service required by the user;
an estimated position of or relative angle to one or more interferers; and
a prospect uplink transmission power of the user.

49. The scheduling apparatus of claim 45, wherein the first signal comprises an acknowledgement message and/or a negative acknowledgement message related to a previous uplink data reception.

50. The scheduling apparatus of claim 45, wherein the second signal comprises an acknowledgement message and/or a negative acknowledgement message related to a previous downlink data transmission.

51. The scheduling apparatus of claim 45, wherein the controlling circuitry is further configured to cause transmission, to one or more users of the third set of users, of downlink data according to the scheduling.

52. The scheduling apparatus of claim 45, wherein the controlling circuitry is further configured to cause transmission, to one or more users of the third set of users, of an uplink scheduling message indicative of the scheduling.

53. The scheduling apparatus of claim 45, wherein the controlling circuitry is further configured to cause:
transmission, to one or more users of a fourth set of users, of downlink data according to the scheduling; and
transmission, to one or more users of a fifth set of users, of an uplink scheduling message indicative of the scheduling,
wherein a union set of the fourth and fifth sets of users coincides with the third set of users.

54. The scheduling apparatus of claim 45, wherein the controlling circuitry is configured to cause the first signal to be specifically directed to each user of the first set of users.

55. The scheduling apparatus of claim 45, wherein the controlling circuitry is configured to cause the first signal to be transmitted using beamforming towards each user of the first set.

56. The scheduling apparatus of claim 45, wherein the first signal is further indicative of, for each user of the first set of users, a communication resource allocated to the user for transmission of the second signal.

57. The scheduling apparatus of claim 45, wherein each of the respective second signals is configured for enabling its originating user to be distinguishable at the scheduling apparatus.

58. The scheduling apparatus of claim 45, wherein the controlling circuitry is configured to cause the reception of each of the respective second signals by causing reception of each of the respective second signals using a respective receiver beamforming direction.

59. The scheduling apparatus of claim 45, wherein the first signal is further indicative of communication resources associated with the second signal and allocated for random access.

60. The scheduling apparatus of claim 45, wherein reception of the respective second signals comprises reception of a respective random access request from one or more users of the first set of users.

61. The scheduling apparatus of claim 45, wherein the multi-user scheduling is in an unlicensed communication environment.

62. A wireless communication apparatus comprising the scheduling apparatus of claim 45.
